(19) United States
(12) Patent Application Publication
(10) Pub. No.: US 2013/0198829 A1
(43) Pub. Date: Aug. 1, 2013

(54) SYSTEM TO RETRIEVE AND DISTRIBUTE IMAGES IN REAL TIME

(71) Applicants: Carsten Bund, Los Angeles, CA (US); Armond Zamanyan, Sunland, CA (US)

(72) Inventors: Carsten Bund, Los Angeles, CA (US); Armond Zamanyan, Sunland, CA (US)

(73) Assignee: Advanced Video Communications, Inc.

(21) Appl. No.: 13/569,075

(22) Filed: Aug. 7, 2012

Related U.S. Application Data
(60) Provisional application No. 61/521,313, filed on Aug. 8, 2011.

(51) Int. Cl. H04L 29/06

(52) U.S. Cl. CPC H04L 63/029
USPC 726/11

(57) ABSTRACT

An image-data acquisition and display system coupled to a network provides a first specified data to an interactive control server system to be accessed by a user for acquiring a second specified data based on the first specified data, and receives third specified data from the ICSS, includes: identifying information associated with the system; a server for coupling to the network for transmitting the identifying information to the ICSS via the network; and a tunnel client coupled to the network to establish, based on the identifying information, a communications tunnel through a firewall to exchange data wait the ICSS via the tunnel, to allow data/commands to be received by and transmitted from the system through the firewall to the ICSS over the network. The firewall allows the third specified data to be received by the system though the tunnel and prevents data/commands from being received by the system.

### CROSS-REFERENCE TO RELATED PATENT APPLICATIONS

This application claims priority to U.S. Provisional Application No. 61/521,313, filed Aug. 8, 2011, incorporated herein by reference in its entirety.

### BACKGROUND

1. Field

Embodiments of the present invention relate generally to systems and methods of transmitting data and, in specific embodiments, to systems and methods of transmitting images over a communication network.

2. Related Art

In secure communications via networks, such as the internet, it is desirable to protect computer systems and other devices from invasion by computer virus, data theft, data damage, and the like, and to protect data to be transmitted securely. A variety of methods and systems are available to provide such protection, such as encryption and firewalls.

In some circumstances, however, it is desirable to provide such protection generally, while enabling authorized communicating parties to permit access to and control of the otherwise protected computer systems and other devices to accomplish a task.

### SUMMARY

Various systems and methods allow viewers of a digital picture frame, tablet, cellular phone, PDA, internet-viewing device, or the like to see another participant with a similar device. The device is a standalone networked device that connected to the internet without a computer. The device includes a camera (and/or data acquisition device) to capture an image data or video at the device to be transmitted to another participant.

### BRIEF DESCRIPTION OF THE DRAWINGS

FIG. 1 illustrates a data and image transmission system in accordance with an embodiment of the disclosure;

FIG. 2 is a generalized representation of a tunnel data packet in accordance with an embodiment of the disclosure;

FIG. 3 is an exemplary session showing transmission of tunnel data packets through a tunnel in accordance with an embodiment of the disclosure;

FIG. 4 shows a system for generating and receiving video imagery in an image distribution and access system in accordance with an embodiment of the disclosure;

FIG. 5 illustrates an exemplary set of rules that may be applied to control an image distribution and access system in accordance with an embodiment of the disclosure;

FIG. 6 shows a system for programming set-up rules for transmission of images to a server and rules for receipt of images at one or more displays from the server in accordance with an embodiment of the disclosure;

FIG. 7 shows the system of FIG. 6 operationally distributing images from a plurality of transmitters to a plurality of receivers via the server, according to rules of image exchange between transmitter/receiver pairs in accordance with an embodiment of the disclosure; and

FIG. 8 illustrates a data and image transmission system in accordance with an embodiment of the disclosure.

### DETAILED DESCRIPTION

In the disclosure, the term “data and image transmission system” may be represented, for convenience, by the term “camera image transmission system” without loss of generality. The term “image-data acquisition system” may be represented by the term “camera image transmission system” without loss of generality.

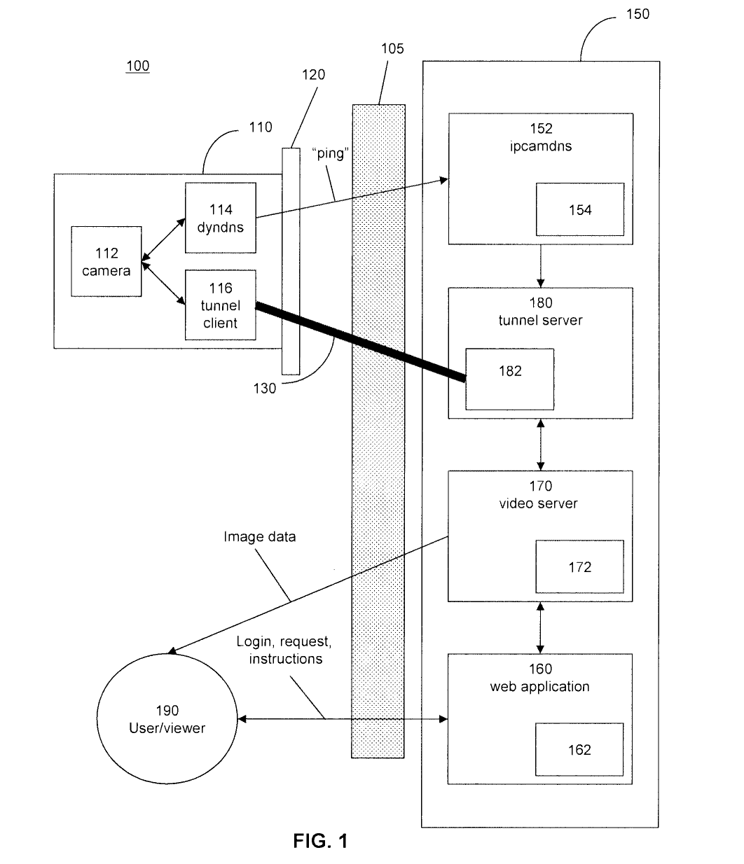

With reference to FIGS. 1-3, a camera image transmission system 100 may include a camera system (or “IP cam”) 110 configured to communicate over a communications network 105 through a secure connection (such as, for example, from behind a firewall 120). The camera image transmission system 100 may be controlled interactively by a remote user/viewer 190 through a communications tunnel 130 by interacting through an interactive control server system 150.

In various embodiments, the camera image transmission system 100 may be described in terms of a camera system 110. In other embodiments, the camera system 110 may more generally refer to any suitable type of data acquisition system (“image-data acquisition system”), such as an audio detector, environmental detector, or any type of sensor, and/or the like. In various embodiments, communication may be described as occurring over the internet. In other embodiments, communication may occur over any type of equivalent communications network.

FIG. 1 depicts the camera image transmission system 100 that includes the communications network (e.g., “internet”) capable camera system 110, which communicates with the interactive control server system 150. The user/viewer 190 may communicate interactively with the camera system 110 through the interactive control server system 150. In specific embodiments, the user/viewer 190 may communicate interactively with the camera system 110 only through the interactive control server system 150. Examples of camera image transmission systems are disclosed in (but not limited to) U.S. patent application Ser. No. 12/478,047, filed on Jun. 4, 2009, which is herein incorporated by reference in its entirety.

The camera system 110 may be configured to communicate from behind a firewall 120 (or equivalent communications security system) to access the communications network 105 (e.g., internet). The firewall 120 is described herein for exemplary purposes only. Other means of providing security and protection of devices such as the camera system 110 may be used without altering the intent of the disclosure.

In various embodiments, the camera system 110 may include, for example, a camera 112 (e.g., a digital audio/video or still camera), a dynamic domain name server (DNS) 114, and a tunnel client 116. The tunnel client 116 will be discussed in more detail below. The server 114 is a protocol or network service that enables the camera system 110 to address and transmit messages to other devices participating in the communications network 105 such as, for example, the interactive control server system 150. Examples of tunnel clients and dynamic domain name servers are disclosed in, but are not limited to, U.S. Pat. No. 7,321,598, which is herein incorporated by reference in its entirety.

The camera system 110 may be identified, for example, by a Media Access Control (MAC) address and/or serial number (SIN), uniquely assigned at time of manufacture of the camera system 110. This identifying information may be provided to and stored in the interactive control server system 150, as described below in more detail, to register the camera system 110 as an approved device for use in the camera image transmission system 100.

When connected to the communications network 105 and provided with power, the camera system 110, via the server 114, autonomously and periodically transmits (“pings”) an identifier message that is received and recognized by the interactive control server system 150. The identifier message may include certain identification information for the camera system 110 (e.g., the MAC address and/or the SIN and, optionally, additional identification information and/or the like.

The interactive control server system 150 may include a dynamic domain name server ipcam server 152. The ipcam server 152 may include a database table (or “camdatabase”) 154 that stores registration information of all approved camera systems 110. In some embodiments, such registration information may be provided separately (e.g., from an approved manufacturer) to the camdatabase 154 before the camera system 110 becomes active and couples to the communications network 105. The “ping” transmitted by the server 114 of the camera system 110 is received by the ipcam server 152. By comparing the identification information in the transmitted “ping” to registration information of camera systems 110 stored in the camdatabase 154, the interactive control server system 150 determines if the transmitting device is one of the approved camera systems 110, and may then recognize that the camera system 110 is available for operational use. The camdatabase 154 may additionally receive and store status data (e.g., active, inactive, available, etc.) from the camera system 110 contained in the identifying information. The camdatabase 154 may further include access data, which may be provided separately, that determine which users/viewers 190 may access which camera systems 110.

The information in the camdatabase 154 enables the interactive control server system 150 to allow service only to registered equipment. The list may be updated, for instance, to include more camera systems 110, for example, as the camera systems 110 become available and are approved to communicate with approved users/viewers 190. Additional information may be stored in the camdatabase 154 as required. For example, additional information may include the physical location, owner, lessor, lessee, and/or the like, of the camera system 110.

The user/viewer 190, operating from a computer or other communications network capable communications device, at a location remote from the camera system 110, can log onto the interactive control server system 150 for the purpose of viewing data, such as a camera feed, from a selected camera system 110 as described in the disclosure.

In various embodiments, the interactive control server system 150 may include a web application 160 to which the user/viewer 190 can log on. In particular embodiments, the logon may be via a conventional link such as the internet 105. The web application 160 accesses a stored user database 162. The user database 162 maintains login identifiers for each user/viewer 190 and is relational in that the user database 162 may include a list of which one or more of the camera systems 110 the user/viewer 190 may access and interact. In further embodiments, the user database 162 may determines whether a subject attempting to log into the interactive control server system 150 is a valid user/viewer 190.

In some embodiments, the web application 160 may be one of a plurality of web applications 160 included in the interactive control server system 150. In further embodiments, the plurality of web applications 160 may be geographically distributed at one or more locations to reduce network latency delays that may exist. In other embodiments, a plurality of web applications 160 may be desirable to handle a large number of user/viewers 190 to reduce a bandwidth limited induced latency.

After the user/viewer 190 is logged on, the web application 160 provides the user/viewer 190 with successive menu driven choices (e.g., as webpage windows using Hypertext Markup Language (HTML)) for the purpose of making a request to specify and receive data (“image data”). The request may include, for example, specifying from which camera systems 110 to provide image data, instructions for controlling the camera systems 110 (e.g., pan, zoom, frame rate, and/or the like), instructions to store or retrieve stored image date from the interactive control server system 150, and/or the like.

As mentioned above, the user/viewer 190 may establish interactive access with a particular camera system 110 by satisfying inputs required in each of the successive web pages for login, camera system selection, requests for video service, camera control scripts, and/or the like. Once the user/viewer 190 has been approved by the web application 160 to have access to one or more of the camera systems 110, a communication channel may be established between the user/viewer 190 and the camera system 110. Because the camera system 110 may operate, for example, from behind a firewall 120, commands are not transmitted to the camera system 110 directly from the user/viewer 190 or from the interactive control server system 150 via the ipcam server 152 and the server 114 because of restrictions of the firewall 120.

To enable access to, and control of the camera system 110 through the firewall 120, the camera system 110 includes a tunnel client 116 to establish a communications channel tunnel 130, hereinafter referred to as a tunnel 130. An example of firewall tunneling is Hypertext Transfer Protocol (HTTP) tunneling, a technique by which communications performed using various network protocols are encapsulated using the HTTP protocol, the network protocols in question usually belonging to the TCP/IP family of protocols. The HTTP protocol therefore acts as a wrapper for a covert channel that the network protocol being tunneled uses to communicate. This enables two-way communication through the firewall 120. The HTTP tunneling technique is exemplary, and other techniques to achieve the same result may be used. The camera system 110 uses the software application tunnel client 116, and the server-side interactive control server system 150 software application is an active connection 182 resident on a tunnel server 180 for communication to the tunnel client 116. Bi-directional communication can take place through the tunnel 130 between the tunnel client 116 and the tunnel server 180 via the active connection 182. The nature of packet data transmission through the tunnel 130 is discussed in the disclosure.

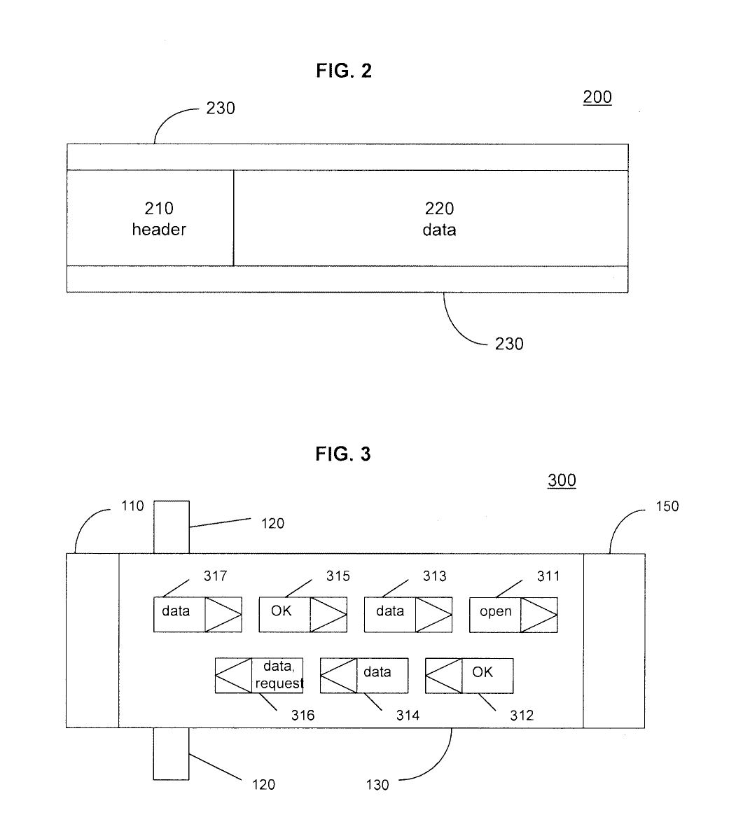

When the camera system 110 is approved for use by the user/viewer 190, and the user/viewer 190 makes a request to receiver image-data from the camera system 110, the tunnel 130 is established between the tunnel client 116 and the active connection 182. Once the tunnel client is aware that the tunnel 130 is established, data packets (e.g., 200 in FIG. 2) may be exchanged bi-directionally between the camera system 110 and the interactive control server system 150.

FIG. 2 depicts a representative tunnel data packet 200. The tunnel data packet 200 includes a header portion 210, a data portion 220 containing, for example, request commands or video data, and, for example, an HTTP tunnel protocol wrapper 230 to enable covert tunnel communication. Other methods and data packaging for tunnel transmission may be contemplated that satisfy the requirements of transmitting data and commands through the firewall 120 (refer to FIG. 1).

FIG. 3 depicts an example of a session of transmission operation 300 through a tunnel 130, as shown in FIG. 1. Referring now to FIGS. 1 and 3, after the camera system 110 has registered its identity and availability with ipcam server 152, a plurality of tunnel data packets e.g., 311-317, may be transmitted. The data packets 311-317 can be transmitted in either direction between the camera system 110 and the interactive control server system 150 as described in the disclosure.

The tunnel client 116 transmits a first data packet 311 (“open”) to the tunnel server 180 in the interactive control server system 150 to confirm that the tunnel 130 is open and communication is available. Data sent from the tunnel server 180 of the interactive control server system 150 to the camera system 110 are provided by the active connection 182, and travel through the tunnel 130, following, for example, the protocol described above.

The active connection 182, operating on the tunnel server 180, returns a confirming tunnel data packet 312 (“OK”) toward the camera system 110. The camera system 110 may then respond, for example, by transmitting a tunnel data packet 313 (“data”) containing its identifier information, such as the manufacturer defined MAC address and SIN. In response, the active connection 182, after referencing the camdatabase 154 or an internal server database 184 that may, for example, be adapted from the camdatabase 154 and/or the user database 162, replies with a tunnel data packet 314 (“data”) that either acknowledges that the camera system 110 is properly registered (such as by verifying, for example, that the camera system 110 is located) and properly identified in one or more of the appropriate databases in the interactive control server system 150 and can further communicate, or may reply that an error has been detected, such as an unregistered camera that may not access the interactive control server system 150.

If the tunnel data packet 314 (“data”) indicates that camera system 110 is recognized, the camera system 110 may respond with a confirming recognition tunnel data packet 315 (“OK”) that it, too, recognizes the interactive control server system 150 and is ready to receive requests and/or commands. The tunnel server 180 may then issue a tunnel data packet 316 (“data, request”) containing a request or operational command, as described above. The camera system 110 may respond by returning, for example, a tunnel data packet 317 (“data”) containing data confirming the requested operation is accomplished, video data or other relevant data response to the request. The alternating exchange of data packets through the tunnel continues until the session is terminated. The session may be terminated by the user/viewer 190 in various ways, for example, including a real time termination, or a scripted termination, as established when the user/viewer 190 initially communicated with the web application 160. The bi-directional data exchange described above is exemplary, and variations of the exchange to accomplish substantially the same outcome are equivalent in accordance with the disclosure.

Referring to FIGS. 1 and 3, the web application 160 then provides the user/viewer 190 with options for selecting and controlling the camera system 110 and for requesting video (or other) data to be returned by transmission through the tunnel 130. On a control web page, for example, various camera control commands may be defined, or selected from a list. This may include, for example, orienting the camera to view one or more locations within the camera line-of-sight, zoom, length of time to dwell on each view, and various other commands. Other types of commands, for example, may include transmitting video data of each view for a selected dwell time, storing the data, specifying limits on data retention, transmitting video data only when motion is detected, and/or the like. Such commands are exemplary, and not limiting to the possible types and combinations of command and data requests that may be contemplated.

The commands are passed from the web application 160 to a video server 170 in the interactive control system 150. The video server 170 stores and maintains a camera specification table 172, which defines the operational specifications of each camera system 110 accessible from the interactive control system 150. The video server 170 constructs camera operation commands according to the operational specifications of the camera 112 within the camera system 110, including commands requesting return of data and processing thereof, such as storage. The camera specification table 172 may be linked to the camdatabase 154 and/or the user database 162, since some information may be commonly and usefully shared.

Commands generated by the video server 170 are then forwarded to the tunnel server 180, where the commands are embedded in data packets constructed for transmission through the tunnel 130. The camera tunnel client 116 interprets or decodes the embedded commands and controls the operation of the camera 112. The camera tunnel client 116 also embeds video data in data packets for transmission through the tunnel 130 back to the tunnel server 180.

The returned video data received by the tunnel server 180 may then be decoded from the data packets and reformatted, for example, in M-JPEG format, and transmitted to the user/viewer 190. The Moving Picture Experts Group M-JPEG format is a standard for video compression and transmission. The software application to perform this reformatting and transmission to the user/viewer 190 may be, for example, resident in the web application 160, video server 170, tunnel server 180, or elsewhere in the interactive control server system 150 depending on various constraints, such as, for example, storage capacity and/or inter-server bandwidth capacity of the servers (either internal or external to the interactive control server system 150).

One can appreciate that video and image-data are not the only forms of information that may be transmitted in this manner. Audio waveforms may be transmitted either separately or associated with video from the camera system 110. In that case, the camera system 110 may be equipped with audio pick-up capability. The audio waveform may be encoded in packets and transmitted through the tunnel 130. Additionally, the camera system 110 may include an audio output capability, so that audio data can be sent to the camera system 110, just as with other data and commands. Audio data may include voice commands, alarms, music, and the like.

The camera system 110 may be configured for non-video data collection, which may be accessed as described above. For example, environmental information may be obtained by a variant of the camera system 110 adapted to collect such data for transmission upon request or under control of a directed script provided by the user/viewer 190. Examples of such data may include remotely monitored radiation and well logging sensor data from remote oil or natural gas fields. The examples given are not intended to be limiting to the adapted configurations and uses of the system 100.

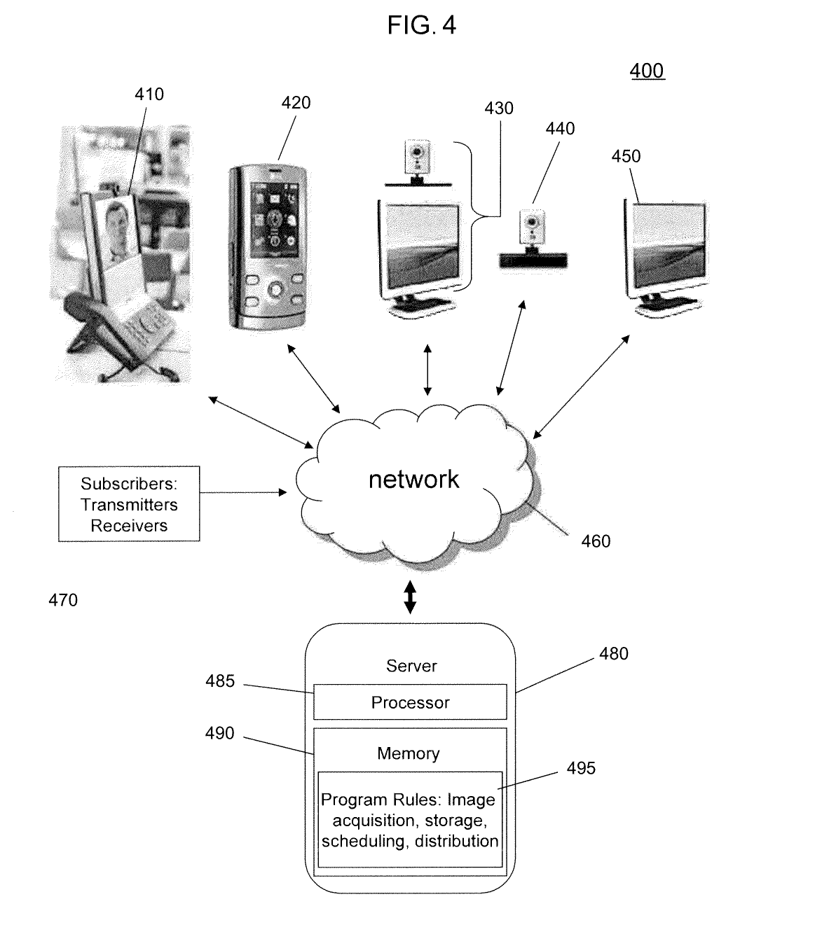

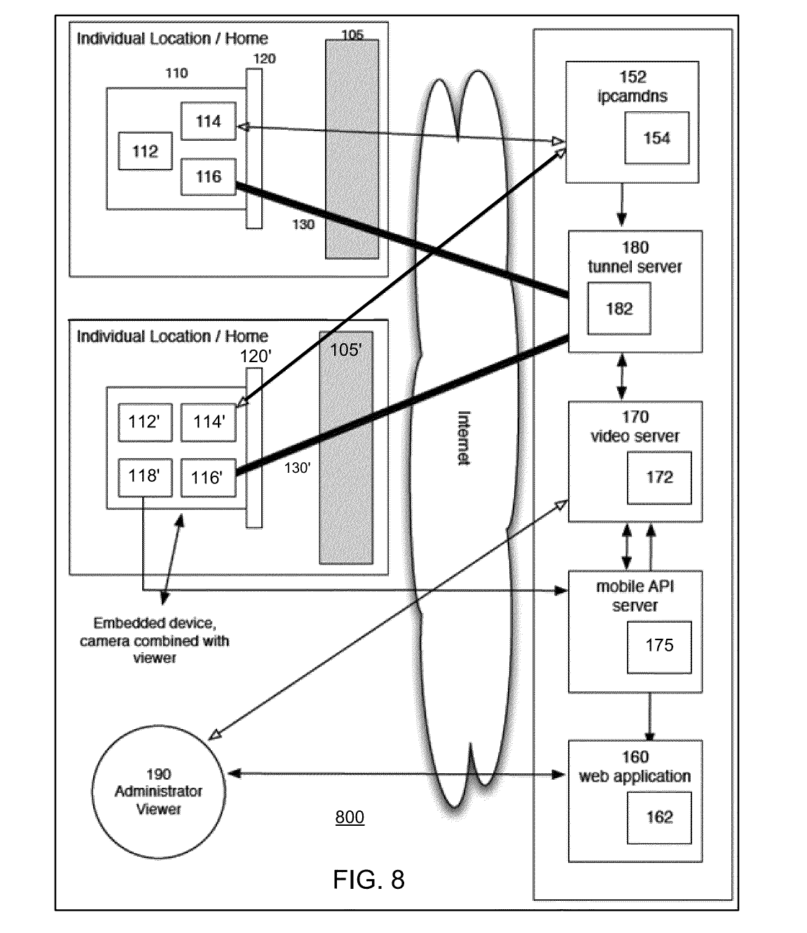

FIG. 4 shows a system 400 for acquisition and distribution of images. Other forms of data than images may be equivalently considered as described herein. Image acquisition and distribution is disclosed as an exemplary embodiment. Various forms of image acquisition and display devices may be used to provide and share images in real- to non-real-time. The principal elements include a node comprised generically of a camera 440, which may be the camera system 110 (e.g., FIG. 1 or 110′ in FIG. 8), to acquire an image, and a display 450, for instance for the user/viewer 190 (e.g., FIG. 1), to present an image. In some instances, the camera 440 and the display 450 may be parts of a single device (e.g., a camera cell phone 420, a desktop video phone 410, and a webcam-equipped computer 430). That is, a node may be both a transmitter (e.g., camera 440) and a receiver (e.g., a display 450) to form a combined transmitter/receiver, or transceiver. The various node combinations may be located at one or more separate locations. Thus, because a transceiver is capable of both providing and receiving imagery or other data (e.g., audio), it may be used to exchange such information with other transceivers, transmitters and/or receivers at other locations.

The various combinations of display and/or camera devices (e.g., 410-450) an be connected via a network 460, to an associated server 480, such as the interactive control server system 150 (refer to FIG. 1) by any appropriate means, such as DSL, cable (including Ethernet), WIFI, WLAN, Bluetooth, wireless telephone, mesh networking, and/or the like. Devices 410-450 are exemplary only and other devices may be contemplated that perform similar data gathering and transmission to the server 480. If the network 460 is, for example, the Internet, the server 480 may be the host of a website (e.g., the web application 162 in FIG. 1) through which all image distribution and access is managed. Furthermore, whereas cameras and displays are discussed in exemplary terms, other devices, such as microphones may be contemplated to acquire audio and speakers may be contemplated to reproduce audio information in the same spirit that cameras and displays acquire and present visual information. Any sensor and transducer may be contemplated as capable of obtaining and/or providing data according the rules of acquisition and distribution.

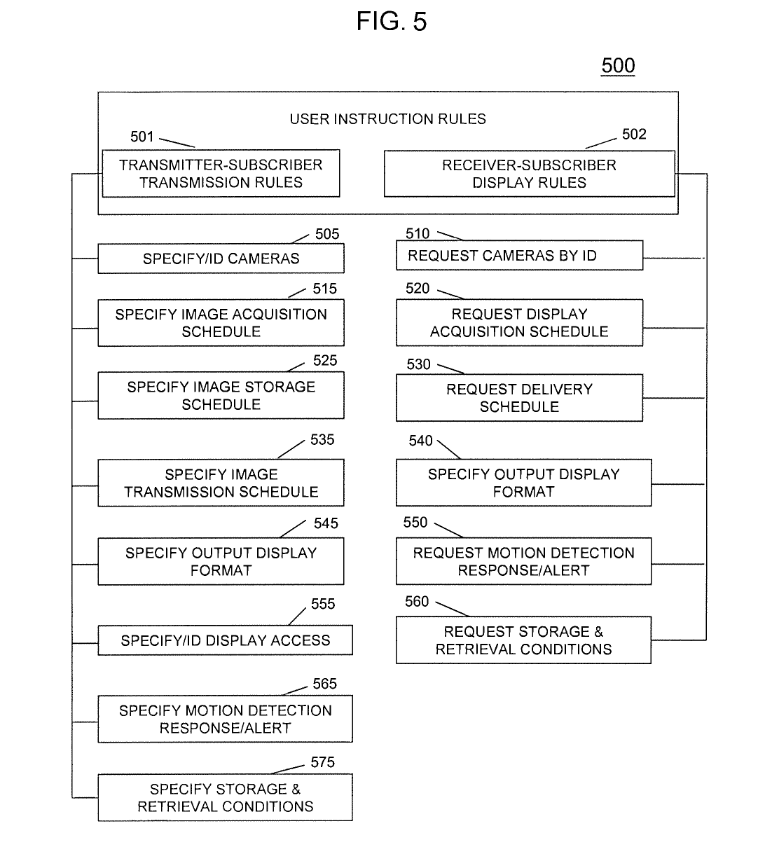

Communications between cameras 440 and displays 450 takes place over the network 460 via the server 480. Subscribers 70 (e.g., transmitters and receivers) control the communications through the server 480. The server 480, which includes a processor 485, is configured to enable a transmitter-subscriber authority to program control of one or more of a plurality of cameras 440 and the transmission of image data from the cameras 440 to the server 480 based on a user specified instruction rule set 500 (described with reference to FIG. 5). The rule set 500 is included in a computer program 495 operable on the processor 485 of the server 480. The server 480 is coupled to a memory 490, i.e., a computer readable medium, which stores the program 495. The program is applied by a transmitter-subscriber authority to develop a customized set of rules to control cameras 440 and by a receiver-subscriber authority to develop a customized set of rules to receive and display data. The memory 490 also stores image data and the like to be downloaded by the server 480 to the display 450. For example, the transmitter-subscriber authority may select rules to control distribution of stored data to authorized receiver-subscribers for display (i.e., transmission rules). The authorized receiver-subscriber may select rules controlling the receipt and presentation format of data to be downloaded from the server 480 (i.e., display rules). For example, the receiver-subscriber may specify frame format (e.g., resolution), frame rate of image data reception, a real-time interval separating the frames, color versus monochrome, split screen multi-image and/or data simultaneous presentation, and the like.

In certain circumstances, a conflict may arise in the rules selected for transmitting data from cameras 440 to the server 480 and rules selected for downloading data from the server 480 to displays 450. In such cases, a provision for conflict resolution is desirable. A set of conflict resolution rules based, for example, on priorities, performance specifications of the cameras 440, displays 450, the communications network 460, and the server 480, may be applied to mediate and overcome incompatible transmission and receiver requests. The processor 485 associated with the server 480 is capable of executing the instructions of each rule set according to conflict rule resolution to receive, store and distribute images or other data.

FIG. 5 illustrates an embodiment of lists of rules 500 that may be applied to control an image distribution and access system 400 (refer to FIG. 4) both from the transmitter-subscriber side and the receiver-subscriber side. With reference to FIGS. 4 and 5, in a set-up (programming mode), a transmitter-subscriber having authority to control one or more cameras 40 has the ability to acquire image data, and may write provisioning rules (e.g., selected from transmission rules 501) to the server 480. The provisioning rules may include (but are not limited to) specifying the origins of images (e.g., which cameras 440) (process block 505); specifying an image acquisition schedule (process block 515); specifying an image storage schedule (process block 525); specifying an image transmission schedule (process block 535) for uploading images to the server 480; specifying output display format provided by the camera 40 (process block 545); specifying receiver-subscribers authorized to access display information (process block 555), such as by matching authorized identification (led) codes, specifying conditions for triggering a response to motion detection (process block 565); and/or the like. There may be several transmitter-subscribers (image providers), each in control of separate (or perhaps overlapping) sets of cameras 440, and a set-up can proceed similarly for each transmitter-subscriber. Additional rules are possible. Where conflicts arise in provisioning programming, conflict resolution rules are invoked.

Each receiver-subscriber may similarly establish rules for receiving images (e.g., by selecting from a set of display rules 502 for image access). These may include (but is not limited to), for example, making a request for one or more cameras 440 to provide images, (e.g., by identifying cameras by an ID (process block 510)); specifying an imagery acquisition schedule for each requested camera (process block 520); specifying a requested imagery delivery schedule to each respective display (process block 530); specifying an output display format appropriate for each respective display (process block 540); specifying conditions for triggering alerts and responses to detection of motion by each camera (process block 250); and specifying requests for storage and conditions of retrieval of image data (process block 560); and/or the like. The list of camera control rules and display/image access request rules is merely exemplary and not intended to be limiting.

The rules may have varying degrees of complexity. For example, each camera 440 (or other data providing device) and each display 450 (or other data receiving device) can have an Internet ID address by which the server 480 identifies both the source and destination of selected data to be stored in the server 480. Each source and each destination have an associated rule set defined by the transmitter-subscriber who is uploading information to the server memory 490 and by the receiver-subscriber designated to receive specific information from the server 480. In some instances, these may be the same party. The transmitter-subscriber may select from the rule set 501 by accessing the server 480 to define parameters for the selection, uploading, manipulation, and storage of images or other data from each source of information. Such parameters may include (but is not limited to) when, under what conditions, how often, and any other parameters controlling the uploading and storing of data.

The receiver-subscriber may make an unscheduled or priority request for images, or other data such as when there might be an emergency, and immediate transmission of an image or data is desired. In some cases, the receiver-subscriber may request image services that conflict with the rules defined by one or more of the transmitter-subscribers and the cameras 440. Resolution of conflicting rules is discussed in (but is not limited to) the disclosure.

The server 460 is configured to receive, store, and distribute images according to the rules set by the transmitter-subscriber and the receiver-subscriber. Between each transmitter-subscriber and each receiver-subscriber, a priority may be set when a conflict arises between transmitter-subscriber and receiver-subscriber rule specification. In some cases limitations from the transmitter-subscriber's rules may prevail over the receiver-subscriber's, and in other cases, the reverse may be true. The priority rules upon which the server 480 delivers image services may differ with each transmitter-receiver relationship. Furthermore, different priorities—e.g., what the transmitter-subscriber authorizes may be sent to the receiver, and what the receiver wishes to receive, or how to receive it—may favor the transmitter-subscriber for some of the rules, and the receiver for other rules.

In some cases sequential images may be of interest, for example, only if motion or a change in the viewed scene is detected. The server 460, then, may be equipped with image processing capability to detect differences in images, for instance, indicative of motion or some event having occurred. In some embodiments, exception rules may be created to trigger certain actions or responses. For example, rules of scheduled image delivery may be overruled and an immediate transmission to a receiver may be initiated (along with other optional communications to alert the receiver-subscriber or some other party).

For example, in a camera security system, it may be advantageous to deploy a system of cameras 440 at various locations of a site, such as a warehouse, a home, medical facility, or location at which human presence is a safety or environmental health hazard. The cameras 440 may be owned, provided, and/or controlled by a plurality of transmitter-subscribers of images. (e.g., as vendors or suppliers). Thus, there may be a plurality of transmitter-subscribers (as image providers), just as there is a plurality of receiver-subscribers requesting visual observation capability in the form of received images. All of the transmitter-subscriber and receivers may interact via the website server 480. In the example of home security, at least one camera 440 may be deployed in and/or around a home property, and displays 50 are not required at that location. In another example, a camera desk phone (e.g., the desktop video phone 410) may double as an office security camera when an office is nominally unoccupied, and the images obtained may be transmitted, according to the selected rule set, via a connection to the server 480.

The transmitter-subscriber can specify and identify which cameras 440 are to be allocated or available. Each camera 440 may have a unique identification (led) number and/or address (e.g., MAC address, S/N, and/or the like), which may be addressed according to transmitter-subscriber instructions sent to the website server 480 selecting from among the transmission rules 501. The transmitter-subscriber defined rules may be generated prior to operation of the system 400 for transmission of images, or they may be altered during operation of the system 400 to change the provisioned image service.

As previously described, the transmitter-subscriber rules control the uploading and possible distribution of image data. For example, from a remote location, the transmitter-subscriber may instruct multiple cameras 440 to obtain images in some order. The image acquisition may be substantially simultaneous for all cameras 440 (i.e., a “snapshot” of all scenes at substantially the same time), and the images are transmitted via the network 460 to the server 480, or the instructions may have the images acquired serially from each camera 440 at intervals and transmitted at a specified frame rate (which may be substantially real-time, e.g., approximately 15-30 frames per second or faster, as a video) or in less than real-time. In cases where only low-bandwidth communication is available, the rate of image transmission may limit the repetition rate at which images can be usefully acquired. The transmitter-subscriber may instruct the images to be available for display individually in a specified order from each camera 440 by identification number, with a certain rate of update. As another example, the receiver-subscriber may instruct the server 480 to provide images in sub-windows of a selected one or more displays (e.g., 450) if, for instance, the displays are capable of such formatting. Other exemplary instructions may include storage of images in the memory 490 for later retrieval and/or in a temporary buffer in the memory 490 to provide the images according to an instruction schedule. Depending on the instructed format and rate of display, a buffer in the memory 490 may or may not be used.

In various embodiments, the images may be displayed, for example, on a display of the cellular phone 20. This provides a significant convenience in that security monitoring can be achieved by one or more monitoring individuals who are mobile and do not wish to be restricted to a fixed viewing location to view data. Alternatively, the displays 450 may be in various fixed locations, and the receiver-subscriber may access images from any of a number of cameras 440 at any of a number of displays 450.

In some embodiments, each camera 440 may transmit its identification number, which the receiver-subscriber may use to identify the location of the camera 440 and the scene being viewed.

In some embodiments, the transmitter-subscriber and/or receiver-subscribers may provide instructions that images obtained by a camera 440 may not be stored unless image analysis (e.g., automated) of acquired frames indicate that motion is detected within a specified time interval. The image analysis instructions, like other instruction, may be stored in the memory 490 as part of a program of executable rules to obtain imagery as specified.

In some embodiments, the imagery provided by the cameras 440 may enable the receiver-subscriber to take appropriate action if the viewed imagery warrants. In the example of automated image analysis, an automatic action may be initiated, such as triggering an alert to responder(s) tasked with taking appropriate actions.

In some embodiments, the system 400 may be configured to facilitate conferencing between two or more transmitter/receiver subscribers to provide transmission of imagery obtained from a plurality of cameras 440 to one or more of a plurality of display devices 450. Audio may be included with image transmission. For conferencing purposes, rules for providing images for transmission may be set by transmitter-subscribers, and rules for receiving images may be set by receiver-subscribers, subject to limitations set by transmitter-subscribers as part of any conflict resolution. For example, in a conference with a plurality of participants, wherein each user participant has a camera/display combination 430, a user may wish to participate but not be viewed by some or all of the other participants. Similarly, a participant may wish only to view imagery from certain participant cameras 440, but not those of certain other participants if, for example, participant determines that visual information from certain participants is not useful, required, or desirable. The visual imagery may be live camera images, graphics images, whiteboard drawing, and/or the like.

In the event of conflicting transmitter/receiver subscriber instructions (e.g., a receiver-subscriber requests imagery in high resolution or on a first schedule, while a transmitter-subscriber provides only medium resolution images or on a less desirable schedule), a control rule may be invoked, and the parties may be alerted of a conflict, which may be resolved by electing a different combination of rules that can be satisfied by both parties. In conferencing, the transmitter-subscriber(s) commonly (but not always) have priority in resolving conflicts.

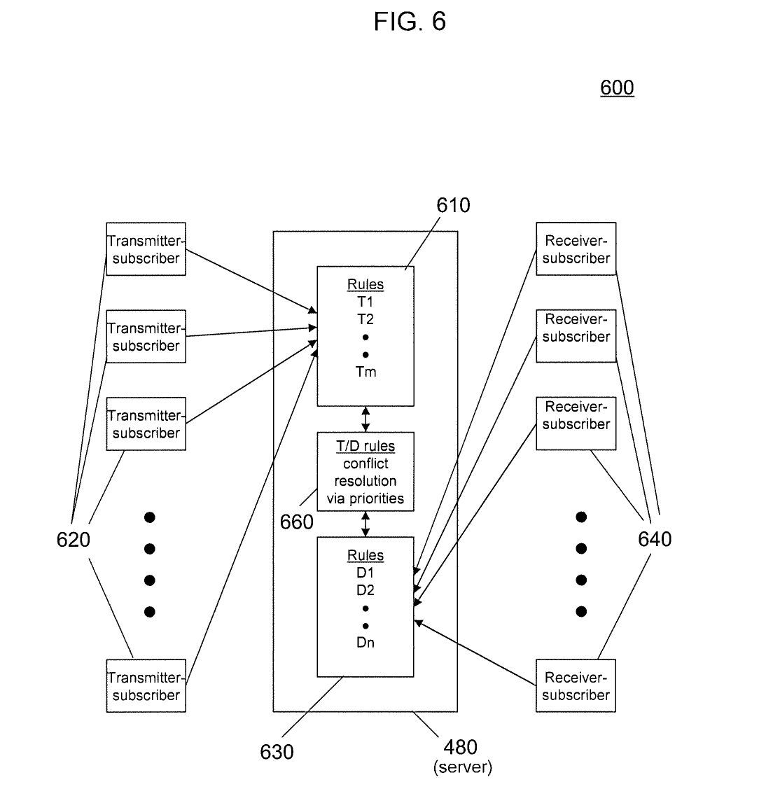

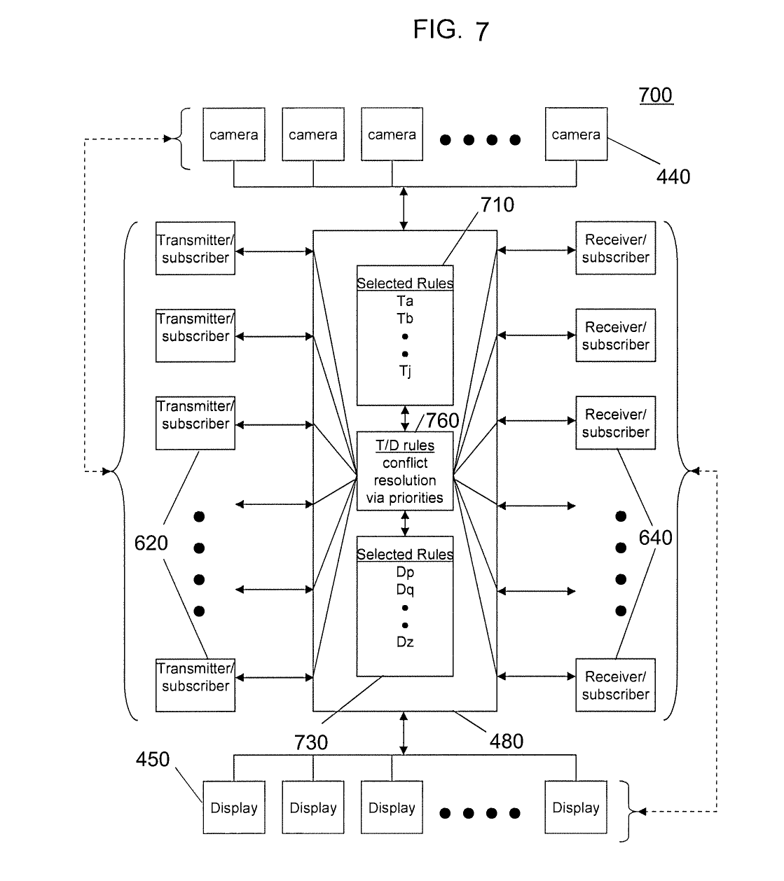

FIG. 6 shows a system 600 for selecting transmission rules 610 for transmitting images from cameras 440 to a server 480 specified by one or more transmitter-subscribers 620 and selecting display rules 630 for receiving images from the server 480 as specified by receiver-subscribers 640 at displays 450. FIG. 7 shows the system 600 of FIG. 6 applied for distributing images from a plurality of cameras 440 to a plurality of displays 450 via the server 480 according to the selected rules of image exchange between camera/display pairs. Referring to FIGS. 6 and 7, transmitter-subscribers 620 may each control a plurality of cameras 440 by selecting from a set of possible transmit rules 610 T₁-Tₘ for transmitting images and/or data from among a plurality of cameras and/or data acquisition devices. The resulting set of selected transmit rules 710 Tₐ-Tⱼ determine the transmission of images from the various cameras 440 to the server 480. Receiver-subscribers 640 may each request and specify imagery and data to be received via the server 480 by one or more of a plurality of displays 450 by selecting from a set of possible display rules 330 D_{I}-Dₙ. The resulting set of selected display rules 730 Dₚ-D_{z} determine the display of images at the various displays 450 sent from the server 480.

Where conflicts arise between the selected transmission rules 710 (i.e., Tₐ-Tⱼ) and the selected display rules 730 (i.e., Dₚ-D_{z}), a set of prioritizing rules (T/D rules) 760 may be used to mediate conflicts between the image/data transmit rules 710 and the image/data display rules 730 (which may differ for each camera-display pair and each transmitter-receiver subscriber pair). New conflict resolution T/D rules 760 can be created as needed to resolve conflicts that may arise out of new transmission and display/data format capabilities and requirements. The image exchange rules are thus a combination of transmit rules 710, display rules 730, and conflict resolving T/D rules 760 that control provisioning of imagery from cameras 440 to displays 450.

In contrast to systems such as social networking websites, image data is acquired and provisioned through a managed website server 480 in near-real-time, if desired. The imagery is useful in immediate or time-sensitive situations. The frame rate of image acquisition or transmittal may be controlled according to communications bandwidth limits or other rules set by the image provider (e.g., transmitter-subscriber) and the image viewer (e.g., receiver-subscriber). In various embodiments, audio information may be transmitted and received according to similar rule setting procedures.

It may be appreciated that, as indicated above, camera imagery is not the only form of data that may be acquired, transmitted, processed (e.g., as to frame rate, storage, resolution, etc.), and distributed to receiving devices for presentation according to rules for acquisition and distribution. For example, in addition to audio data, mentioned above, other forms of information may be managed in like manner, such as environmental sensory data, to enable monitoring and control of hazardous or remote environments.

FIG. 8 shows a camera image transmission system 800, which, in some embodiments may include similar components and/or be configured like the camera image transmission system 100 (refer to FIGS. 1-3) and/or the system 400 (refer to FIG. 4). The camera image transmission system 800 may include a first camera system (or “IP cam”) 110 (e.g., refer to FIGS. 1-3). The camera image transmission system 800 may also include a second camera system 110′.

The first camera system 110 may be located at a first location remote from a second location at which the second camera system 110′ is located. Thus, for instance, the first camera system 110 and the second camera system 110′ may be associated with a respective first firewall 105 and second firewall 105′.

According to various embodiments, the second camera system 110′ at least includes the same components (e.g., camera 112, server 114, and tunnel client 116) and/or is configured as the first camera system 110. In particular embodiments, the second camera system 110′ includes a display 118′ (e.g., 450 in FIG. 4). The display 118′ may be for displaying images or video, for example, received from the interactive control server system 150 (or 480 in FIG. 4) and/or captured from the camera 112′. In some embodiments, the second camera system 110′ (or components thereof) may be or may be implemented with any display device having image acquisition and transmission capabilities, such as (but not limited to) a digital picture frame, tablet device (e.g., iPad, Android-based tablet, and/or the like), PDA, cellular phone (e.g., 420 in FIG. 4), video phone (e.g., 410 in FIG. 4) internet display device, etc. In some embodiments, the first camera system 110 also includes a display device (not shown).

In particular embodiments, the second camera system 110′ may be implemented (at least in part) as an application or software executed on such devices. For instance, such an application would implement a camera and display of such a device as the camera 112′ and the display 118′, respectively, and the application would provide, for instance, the tunnel client 116′ and/or the server 114′.

In various embodiments, the display 118′ displays images or video captured by the camera 112′ or images or video captured by another camera (e.g., the first camera system 110), as retrieved from the server 150, in the camera image transmission system 800. In some embodiments, the display 118′ may also display images and/or video stored locally in a memory of the second camera system 110′ and/or images or video retrieved from a remote location (e.g., from the first camera system 110 via the interactive control server system 150). The second camera system 110′ may supply images or video captured by the camera 112′ to the interactive control server system 150 as previously described, for example, with respect to the first camera system 110.

In some embodiments, the interactive control server system 150 may include a mobile API server 175 or the like for communicating with the second camera system 110′ (and/or the first camera system 110). The API server 175 may communicate directly with the display 118′. For example, image data can be transmitted from the API server 175 of the interactive control server system 150 to the display 118′. Therefore, in particular embodiments, the image data does not need to be transmitted to the second camera system 110′ via the second communication tunnel 130′.

In various embodiments, the second camera system 110′ includes a motion sensor (not shown) for detecting motion proximate the second camera system 110′. Detection of motion may activate the second camera system 110′, for instance, to begin capturing images or video and, optionally, transmitting the captured images or video, or to take other desired actions. In various embodiments, the second camera system 110′ may include any suitable sensor (or additional sensors), such as but not limited to the sensors described in the disclosure, that activates the second camera system 110′ (or triggers some other action) when a certain parameter is detected or exceeds a predetermined threshold. For instance, the second camera system 110′ may include a microphone (not shown) such that the second camera system 110′ activates when the microphone detects a decibel level, for example, over 55 dB (i.e., roughly the sound level of human speech). Thus, the second camera system 110′ would activate upon detecting the presence of one or more humans speaking nearby. In various embodiments, the first camera system 110 may include any suitable sensor as well.

In various embodiments, the second camera system 110′ maintains a persistent connection with the interactive control server system 150, for instance, as described in the disclosure (e.g., via a second communication tunnel 130′ through the second firewall 105′). As such, the second camera system 110′ is able to transmit images or video, receive images or video or commands (e.g., from the user 190 or the second camera system 110′) indefinitely (so long as the persistent connection (e.g., communication tunnel) with the interactive control server system 150 is maintained). The first camera system 110 maintains a persistent connection with the interactive control server system 150, for instance, as described in the disclosure (e.g., via a first communication tunnel 130 through the first firewall 105). As such, the first camera system 110 is able to transmit images or video, receive images or video or commands (e.g., from the user 190 and/or the second camera system 110′) indefinitely (so long as the persistent connection (e.g., communication tunnel) with the interactive control server system 150 is maintained).

In embodiments in which the second camera system 110′ is implemented as an application or software on a tablet, cellular phone, PDA, internet display device, or the like, once established (e.g., first use of the application after restart, upon startup of the device, etc.), the second communication tunnel 130′ may persist indefinitely while the application is open or otherwise active. In some embodiments, the second communication tunnel 130′ persists after closing (or minimizing in other embodiments) the application. In such embodiments, for instance, closing the application may deactivate some components or modules (e.g., the camera 112′), while maintaining other components or modules (e.g., the tunnel client 116′ to maintain the second communication tunnel 130′). In other embodiments, the second communication tunnel 130′ is maintained until specifically closed by the user. For instance, to close the second communication tunnel 130′, the user would select an option to close the second communication tunnel 130′ when closing the application. Accordingly, in various embodiments, when the application is later activated (e.g., opened, maximized, etc.), there is no need to establish a new communication tunnel. In some embodiments, the camera system application (or the second camera system 110′) may re-activate upon detection by a sensor, receiving a remote command, for example, from the user 190, and/or the like. For example, after previously establishing a communication tunnel 130, the user 190 (or another camera system, such as the first camera system 110) can immediately begin transmitting video data (or the like) to a user of the second camera system 110′ even if the application is closed or minimized.

In some embodiments, the user 190 may be using a remote device, such as a computer, mobile device, or the like to communicate with the camera system 800. As discussed, the user 190 can send login information, requests, instructions or the like to the first camera system 110 or the second camera system 110′ to control the cameras accordingly. The user 190 may obtain image data (or the like) from the first camera system 110 or the second camera system 110′ via the interactive control server system 150.

In some embodiments, the user may use one of the camera systems (e.g., the first camera system 110 or the second camera system 110′) in the camera system 800. Thus, for example, the user at the second camera system 110′ can use the second camera system 110′ to send login information, requests, instructions or the like to the first camera system 110 via the interactive control server system 150 to control the first camera system 110 accordingly. Likewise, the user at the second camera system 110′ can use the second camera system 110′ to receive image data (or the like) from the first camera system 110 via the interactive control server system 150.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. Such hardware, software, firmware, or any combination thereof may be part of or implemented with any one or combination of the first camera system 110, the second camera system 110′, the interactive control server system 150, and/or the like. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. An image-data acquisition and display system coupled to a communications network for providing a first specified data to an interactive control server system to be accessed by a user device for acquiring a second specified data based on the first specified data, and for receiving third specified data from the interactive control server system, the image-data acquisition and display system comprising:
at least a digital video camera or a digital still camera for acquiring the first specified data;
a display device for displaying the third specified data received from the interactive control server system;
unique identifying information associated with the image-data acquisition and display system;
a server for coupling to the communications network operable to periodically transmit an identifier message including at least the unique identifying information to the interactive control server system via the communications network; and
a tunnel client coupled to the communications network to establish a communications tunnel through a communications security firewall to receive and transmit data from the interactive control server system via the communications tunnel, the communications tunnel established on the basis of the transmitted unique identifying information to allow data and commands to be received by and transmitted from the image-data acquisition and display system through the communications security firewall to the interactive server system over the communications network;
wherein the communications security firewall allows the third specified data to be received by the image-data acquisition and display system though the communications tunnel and prevents data and commands from being otherwise received by the image-data acquisition and display system.

2. The image-data acquisition and display system of claim 1, further comprising a sensor.

3. The image-data acquisition and display system of claim 2, wherein the sensor is at least one of an audio detector and an environmental sensor.

4. The image-data acquisition and display system of claim 2, wherein the sensor is a motion sensor for detecting motion proximate the image-data acquisition and display system.

5. The image-data acquisition and display system of claim 4, wherein the first specified data is transmitted to the interactive control server system in response to the motion sensor detecting motion.

6. The image-data acquisition and display system of claim 2,
wherein the sensor is configured to sense a parameter; and
wherein the first specified data is transmitted to the interactive control server system in response to the motion sensor sensing the parameter.

7. The image-data acquisition and display system of claim 6,
wherein the sensor is configured to sense a parameter; and
wherein the first specified data is transmitted to the interactive control server system in response to the motion sensor sensing the parameter at or exceeding a predetermined threshold.

8. The image-data acquisition and display system of claim 1, wherein the communications network comprises the internet.

9. The image-data acquisition and display system of claim 1, wherein the communications tunnel is a Hypertext Transfer Protocol tunnel.

10. The image-data acquisition and display system of claim 1, wherein the communications tunnel is maintained, after being established, when the first specified data is not being transmitted from the image-data acquisition and display system and the third specified data is not being received to the image-data acquisition and display system.

11. The image-data acquisition and display system of claim 1, wherein the tunnel client is configured to transmit, based on the instructions, at least a portion of the first specified data to the interactive control server system through the communication tunnel for storage and reformatting into the second specified data by the interactive control server system.

12. The image-data acquisition and display system of claim 1, wherein the third specified data corresponds to fourth specified data, wherein at least a portion of the fourth specified data is transmitted from the user device to the interactive control server for storage and reformatting into the third specified data by the interactive control server system

13. A method of providing over a communications network a first specified data from an image-data acquisition and display system to an interactive control server system to be accessed by a user device for acquiring a second specified data based on the first specified data, and for receiving third specified data from the interactive control server system, the method comprising:
associating unique identifying information with the image-data acquisition and display system;
transmitting periodically from the image-data acquisition and display system an identifier message including at least the unique identifying information, to the interactive control server system via the communications network;
establishing a communications tunnel with a tunnel client coupled to the communications network through a communications security wall to transmit the first specified data to and receive the third specified data from the interactive control server system via the communications tunnel, the communications tunnel established on the basis of the unique identifying information to allow data and commands to be received by and transmitted from the image-data acquisition and display system through the communications security firewall;
providing the first specified data from at least one of a digital video camera and a digital still camera; and
displaying the third specified data received from the interactive control server system.

14. An interactive control server system coupled to a communications network for receiving a first specified data from a remote device and transmitting a second specified data to a remote device over the communications network, and for transmitting a third specified data from the remote user to the remote device, the interactive control server system comprising:
a memory to store at least a portion of the first specified data received from the remote device over the communications network and at least a portion of the third specified data received from the remote user over the communications network;
a user database stored in the memory to maintain a list of prior approved remote users to determine if a given user is an approved remote user;
a web application to exchange information with the approved user to and from the interactive control server system over the communications network;
a device database stored in the memory to maintain a list of prior approved remote devices allowed to communicate with the interactive control server system, the device database including the operational specifications of the approved remote devices;
a device name server to receive identification signals from the approved remote device over the communications network;
a tunnel server to transmit formatted data to and receive from the approved remote device over the communications network, wherein the approved remote device is coupled to the communications network from behind a communications security firewall; and
a video server to transmit the second specified data reformatted for presentation to the approved remote user from the interactive control server system over the communications network.

15. The interactive control server system of claim 14, wherein the communications network comprises the internet.

16. The interactive control server system of claim 14, wherein the communications tunnel is a Hypertext Transfer Protocol tunnel.

17. A method of receiving by an interactive control server system coupled to a communications network a first specified data from a remote device and transmitting a second specified data to a remote user, and transmitting a third specified data from the remote user to the remote device, the method comprising:
receiving, at the interactive control server system, at least a portion of the first specified data from the remote device over the communications network;
receiving, at the interactive control server system, at least a portion of the third specified data from the remote user over the communications network;
storing at least a portion of the first specified data and the third specified data in the memory of the interactive control server system;
storing a user database in the memory to maintain a list of prior approved remote users to determine if a given user is an approved remote user;
serving a web application on the interactive control server system to exchange information with the approved remote user to and from the interactive control server system over the communications network;
storing a device database in the memory to maintain a list of prior approved remote devices allowed to communicate with the interactive control server system, the device database including the operational specifications of the approved remote devices;
receiving identification signals, at the interactive control server system, from an approved remote device over the communications network;
transmitting to and receiving formatted data from the approved remote device over the communications network, wherein the approved remote device is coupled to the communications network from behind a communications security firewall; and
transmitting, from a video server of the interactive control server system, the second specified data reformatted for presentation to the approved remote user over the communications network.
